(19) United States
(12) Patent Application Publication
(10) Pub. No.: US 2025/0321813 A1
(43) Pub. Date: Oct. 16, 2025

(54) DATA ENRICHMENT VIA A NUMBER OF DATA MODELS AS A FUNCTION OF ELECTRONIC MESSAGES ASSOCIATED WITH A SYSTEM OF VARIOUS NETWORKED COMPUTING DEVICES

(71) Applicant: Khoros, LLC, Austin, TX (US)

(72) Inventors: Ryan Studer, Lees Summit, MO (US); Jeffrey Yentis, Potomac, MD (US); Justin August Fellers, Austin, TX (US); Gijs van de Nieuwegiessen, Berkel-Enschot (NL); Nicholas Anthony Hill, Lake Oswego, OR (US)

(73) Assignee: Khoros, LLC, Austin, TX (US)

(21) Appl. No.: 18/634,882

(22) Filed: Apr. 12, 2024

(51) Int. Cl. G06F 9/54

(52) U.S. Cl. CPC G06F 9/546; G06F 2209/543

(57) ABSTRACT

Various embodiments relate generally to data science and data analysis, computer software and systems, and control systems to provide a platform to facilitate implementation of an interface as a computerized tool, among other things, and, more specifically, to a computing and data platform that implements logic to facilitate moderation of electronic messages, postings, content, etc., via implementation of an application configured to, for example, perform one or more actions automatically implementing one or more data models (or a combination of data models), such as large language models (“LLMs”) or any other machine-learning algorithms.

### FIELD

Various embodiments relate generally to data science and data analysis, computer software and systems, and control systems to provide a platform to facilitate implementation of an interface as a computerized tool, among other things, and, more specifically, to a computing and data platform that implements logic to facilitate moderation of electronic messages, postings, content, etc., via implementation of an application configured to, for example, perform one or more actions automatically implementing one or more data models (or a combination of data models), such as large language models (“LLMs”) or any other machine-learning algorithms.

### BACKGROUND

Advances in computing hardware and software have fueled exponential growth in delivery of vast amounts of information due to increased improvements in computational and networking technologies. Also, advances in conventional data network technologies provide an ability to exchange increasing amounts of generated data via various electronic messaging platforms. Thus, improvements in computing hardware, software, network services, and storage have bolstered growth of Internet-based messaging applications, such as social networking platforms and applications, especially in an area of exchanging digital information concerning products and services to facilitate customer care operations, as well as online communities. For example, various organizations and corporations (e.g., retailer sellers) may exchange information through any number of electronic messaging networks, including social media networks. Such entities aim to respond quickly and efficiently to messages from customers (and potential customers) to manage brand loyalty and reputation, and to bolster customer engagement.

And since different customers prefer communicating over different communication channels (e.g., social media networked channels and communities of electronic messages) and various different data networks, traditional customer-relationship management (“CRM”) computing systems and processes are not well-suited to adapt to engage and moderate communities of customers and associated computing devices at convenience of the customers “on-the-go.”

Social media networks and communities can be found in widespread use as there are many different types and categories often reaching as many as a billion or more users, electronic messages, or units of content, which include various types of content, such as pictures, text, video, audio, multimedia, or any combination thereof. Social media networks and communities are increasingly prolific and can range in scope, size, interest, and reach. Social media networks and communities, in some cases, can be integrated with websites, platforms, or other online properties for specific interests or purposes, which may be social, commercial, governmental, educational, academic, professional, technical, etc.

Various social media networks, websites, and communities can require communities of content to meet certain standards, terms, or conditions that are social, cultural, or legal in nature, which require compliance and, consequently, can often reduce or limit what content may be posted online. Generally, profane or hateful content, threatening content, perjurious commercial speech, and the like, may violate policies and terms of use of a community, which, if unmoderated, can result in social detriment, legal liability, breach of cultural values and mores (e.g., alongside laws, rules, and regulations), or other deleterious effects. In other cases, fraudulent product reviews may damage the online goodwill and perceived value of a company and its products.

To enforce compliance and avoid inappropriate content from being posted into a community of content and electronic messages, traditional social media networks and communities implement conventional social media networks, platforms, platform technologies, and software to monitor, moderate, and manage content and electronic message prior to posting. Conventionally, employees or other personnel (e.g., of various social media networks, platforms, platform providers, and software developers that provide products or services) may be required, as moderators, to read, review, or otherwise scrutinize content intended to be posted to one or more social media networks, or to online communities and groups.

Moderators may be required to review and act on hundreds, thousands, or perhaps hundreds of thousands of items, uploads, or other postings (e.g., electronic posts, messages, units of content, etc.) to ensure compliance with terms (e.g., terms of use), conditions, policies, laws, regulations, rules, and the like. However, conventional moderation techniques and software, including those integrated with existing social media management platforms are generally inefficient, expensive, time-consuming, and usually cumbersome to maintain given the increasing amounts of posting submissions.

Various drawbacks to traditional techniques to moderation using known computing devices and software can often lead to fatigue, resulting in lapses in focus, inadvertent posts, errors, and the like, which may create significant cost and effort to correct. Erroneously moderated content, which may result in propagation of unmoderated content, can also detrimentally affect cohesiveness, trustworthiness, reliability, and reputations of online communities. Further, suboptimal moderation techniques using computing devices and moderator software may increase risk of civil and criminal penalties for unmoderated speech or content that is regulated by law (e.g., violations of Americans with Disabilities Act, or “ADA”).

In addition, incorrect or suboptimal content, or no content, may be posted into a community which may cause customer frustration and dissatisfaction, and can typically be projected negatively unto a corporation and its brand.

Thus, what is needed is a solution for facilitating techniques that optimize self-servicing of solutions for a community and/or a brand through computer utilization and performance associated with moderating content and/or electronic messages, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting an electronic message platform to facilitate moderation of subsets of electronic content, according to some embodiments;

FIG. 2 illustrates an exemplary layered architecture for implementing a moderator application, according to some examples;

FIG. 3 is a flow diagram as an example of moderating an electronic message, according to some embodiments;

FIG. 4 is an example of an architecture to implement an orchestration engine, according to some examples;

FIG. 5 is an example of an architecture that may implement or interface with any number of model data generators in an agnostic manner, at least in some examples;

FIG. 6 is a diagram depicting an implementation of an exemplary persona data engine, according to some examples;

FIG. 7 depicts examples of model APIs to access any number of model data applications and generators in accordance to some examples;

FIG. 8 depicts an example of a system architecture to provide a computing platform to host a syndication of electronic messages and posts for moderation, according to an example; and

FIG. 9 is a diagram depicting an example of an electronic message response platform configured to moderate content and/or electronic messages, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents thereof. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language, service, class, resource, specification, protocol, or other computing or network attributes. As used herein, “software” or “application” may also be used interchangeably or synonymously with, or refer to, a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) or software, or any combination thereof, that may use one or more local, remote, distributed, networked, or computing cloud (hereafter “cloud”)-based computing resources (e.g., computers, clients, servers, tablets, notebooks, smart phones, cell phones, mobile computing platforms or tablets, and the like) to provide an application, operating system, or other computing environment, such as those described herein, without restriction or limitation to any particular implementation, design, configuration, instance, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, or state) may be used for processing and/or storage of varying quantities, types, structures, and formats of data, without restriction or limitation to any particular implementation, design, or configuration.

As used herein, data may be stored in various types of data structures including, but not limited to databases, data repositories, data warehouses, data stores, or other data structures configured to store data in various computer programming languages and formats in accordance with various types of structured and unstructured database schemas such as SQL, MySQL, NoSQL, DynamoDB™, etc. Also applicable are computer programming languages and formats similar or equivalent to those developed by data facility and computing providers such as Amazon® Web Services, Inc. of Seattle, Washington, FMP, Oracle®, Salesforce.com, Inc., or others, without limitation or restriction to any particular instance or implementation. DynamoDB™, Amazon Elasticsearch Service, Amazon Kinesis Data Streams (“KDS”)™, Amazon Kinesis Data Analytics, and the like, are examples of suitable technologies provide by Amazon Web Services (“AWS”).

Further, references to databases, data structures, or any type of data storage facility may include any embodiment as a local, remote, distributed, networked, cloud-based, or combined implementation thereof. For example, social networks and social media (e.g., “social media”) using different types of devices may generate (i.e., in the form of posts (which is to be distinguished from a POST request or call over HTTP) on social networks and social media) data in different forms, formats, layouts, data transfer protocols, and data storage schema for presentation on different types of devices that use, modify, or store data for purposes such as electronic messaging, audio or video rendering, content sharing, or like purposes. Data may be generated in various formats such as text, audio, video (including three dimensional, augmented reality (“AR”), and virtual reality (“VR”), or others, without limitation, for use on social networks, social media, and social applications (e.g., “social media”) such as Twitter® of San Francisco, California, Snapchat® as developed by Snap® of Venice, California, Messenger as developed by Facebook®, WhatsApp®, or Instagram® of Menlo Park, California, Pinterest® of San Francisco, California, LinkedIn® of Mountain View, California, as well as community-based networks, such as Khoros® Community as provided by Khoros, LLC of Austin, Texas, and others, without limitation or restriction.

In some examples, data may be formatted and transmitted (i.e., transferred over one or more data communication protocols) between computing resources using various types of data communication and transfer protocols such as Hypertext Transfer Protocol (“HTTP”), Transmission Control Protocol (“TCP”)/Internet Protocol (“IP”), Internet Relay Chat (“IRC”), SMS, text messaging, instant messaging (“IM”), File Transfer Protocol (“FTP”), or others, without limitation. As described herein, disclosed processes implemented as software may be programmed using Java®, JavaScript®, Scala, Python™, XML, HTML, and other data formats and programs, without limitation. Disclosed processes herein may also implement software such as Streaming SQL applications, browser applications (e.g., Firefox™) and/or web applications, among others. In some example, a browser application may implement a JavaScript framework, such as Ember.js, Meteor.js, ExtJS, AngularJS, and the like. References to various layers of an application architecture (e.g., application layer or data layer) may refer to a stacked layer application architecture such as the Open Systems Interconnect (“OSI”) model or others.

In some examples, systems, software, platforms, and computing clouds, or any combination thereof, may be implemented to facilitate online “communities” of subsets of units of content, postings, electronic messages, and the like. In some cases, units of content, electronic postings, electronic messages, and the like may originate at social networks, social media, and social applications, or any other source of content.

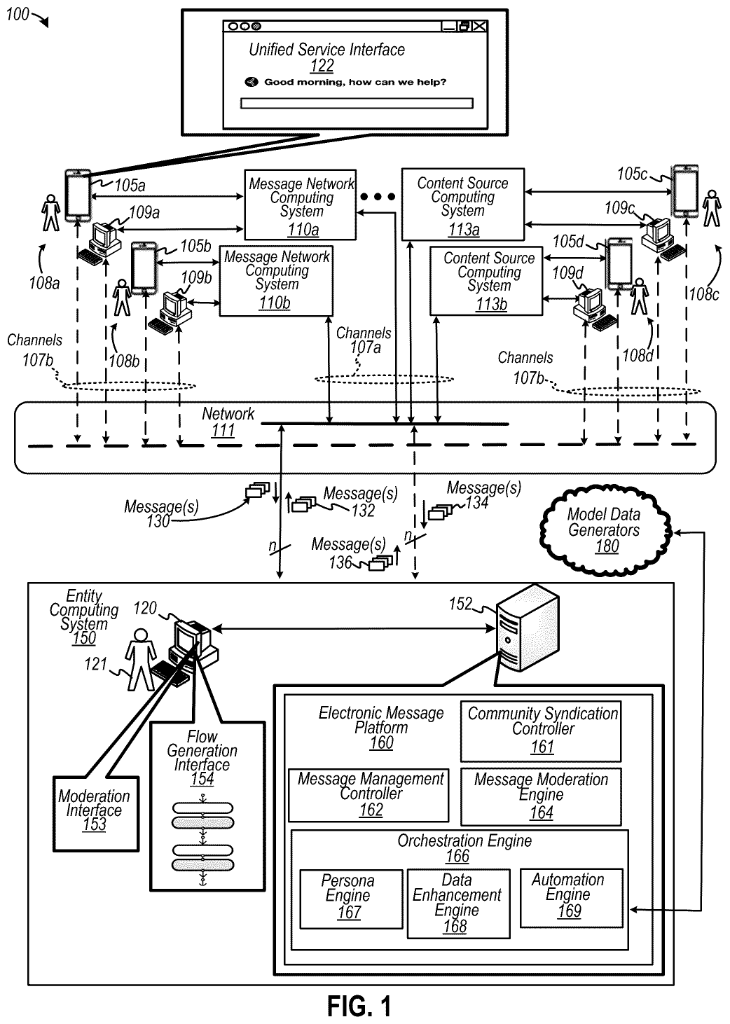

FIG. 1 is a diagram depicting an electronic message platform to facilitate moderation of subsets of electronic content, according to some embodiments. Diagram 100 depicts an example of an entity computing system 150 including an electronic message platform 160 that may be configured to, among other things, facilitate moderation of electronic messages, postings, content, etc., via implementation of a moderator application and/or computing device configured to, for example, perform one or more actions automatically. Further, entity computing system 150 may be configured to generate and present a unified service interface 122 at any client computing device to provide a “conversational” customer interface through which a user, such as user 108a, may receive self-service information via automation in association with automation engine 169 or an agent respondent 121 (e.g., “agent assist” information). In some examples, unified service interface 122 may be implemented as a single or sole interface or destination for accessing information regarding questions or issues of a product or service associated with an entity.

Entity computing system 150 may include an orchestration engine 166, which, in turn, may include a persona engine 167, a data enhancement engine 168, and automation engine 169. Data enhancement engine 168 may be configured to automatically implement one or more data models (or a combination of data models), such as large language models (“LLMs”) or any other machine-learning algorithms to, for example, provide automated moderation and resolution based on any contents of any electronic message (e.g., messages 130 and 134) regardless of communication channels 107b, 107a, or the like. Thus, entity computing system 150 may receive electronic messages via any communication channels 107b, 107a, etc. to receive content via an “omnichannel.” Data enhancement engine 168 also may be configured to automatically implement one or more data models (e.g., LLMs) to modify or generate proposed responsive content to subsequent messages 130 and 134 having similar content (e.g., seeking information regarding an entity's product or service—as a “brand.”). In some examples, data enhancement engine 168 also may be configured to automatically implement via APIs any one of model data generators 180, which may include one or more data models (e.g., LLMs) or any other machine-learning or deep-learning algorithms. Examples of model data generators 180 include any product or service OpenAI™ and variant of ChatGPT™, Vertex AI™ of Google or Alphabet, Inc., and other equivalent or similar “artificial intelligence” or machine-learning services or products.

For example, data enhancement engine 168 may include logic to create information (e.g., as a knowledge article) that may be presented automatically to users 108a, 108b, 108c, and 108d at respective computing devices 105a, 109a, 105b, 109b, 105c, 109c, 105d, and 109d, among others. In some instances, information as a knowledge article may be moderated by an agent user 121 via computing device 120. Such knowledge articles may be promoted or published to a community of users, regardless of electronic medium (e.g., via a social network, an email, a text message, a voice-generated response, “chat” messaging, search algorithms, such as search engine optimization (“SEO”), and the like). Moreover, data enhancement engine 168 may include logic to predict, generate, or propose to an agent user 121 one or more optimal responses (e.g., a “next best action”) with which to respond to messages 130 and 134. Therefore, data enhancement engine 168 may be configured to provide a “self-learning” loop via one or more data models (e.g., LLMs), algorithms configured to implement retrieval-augmented generation (“RAG”) techniques, or any other machine-learning or deep-learning algorithms to generate automated responses or solutions. Data enhancement engine 168 may be configured to generate or identify insight data as to prominent issues via content of messages 130 and 134 and opportunities to resolve such issues in real-time (or near real-time).

Automation engine 169 of orchestration engine 166 may be configured to provide automation, such as automated responses via rules-based algorithms. An example of automation algorithms may include “bots,” such as a chat bot, or audio/voice-generated bot. Automation engine 169 may also be configured to provide a moderation interface 153 through which an agent user 121 may respond to messages 130 and 134 (e.g., based on predicted responses generated by data enhancement engine 168). Automation engine 169 may be configured to provide a flow generation interface 154 as a “page builder” or “flow builder” algorithm or application (e.g., a low-code/no-code application) that may be configured to orchestrate automated responses via automated algorithms (e.g., bots) in accordance with, for example, rules-based logic that may be configured to determine routing of responsive messages 132 and 136 to optimal automated responses or to user, such as agent user 121, or to any user having expertise related to contents of messages 130 and 134 (e.g., routing to an advocate or a knowledgeable user of a community of on-line users).

Persona engine 167 of orchestration engine 166 may be configured to provide personalized responses from a variety of knowledge data sources (e.g., in a community of on-line data users, such as in a social network, or any other networked data source accessible via network 111). Persona engine 167 may be configured to facilitate electronic communications with advocates for an entity (e.g., customer advocates, partners, employees of an entity, etc.) that, for example, may in engage in electronic information exchanges via a community or any other website page (or electronic medium) to advance self-servicing of questions or issues of an entity's product or service. Persona engine 167 may be configured to characterize attributes of a user account (and associated user) that may classified as an advocate or expert that may provide self-service information and solutions relating to content associated with messages 130 and 134. Persona engine 167 can generate persona data of users by evaluating needs within a customer life cycle and analyzing customer details like demographics of a user, transaction history of a user, and net promoter scores (“NPS”) as well as customer satisfaction scores (“CSAT”) of a user.

Orchestration engine 166 may include hardware or software, of any combination thereof, configured to analyze exchanges of electronic messages with entity computing system to determine and identify data to calibrate implementation of operation of data enhancement engine 168 and one or more data models (e.g., LLMs). For example, orchestration engine 166 may analyze exchanges of electronic messages originating from agent user 121 or any other user 108a, 108b, 108c, and 108d who may be classified as an “advocate” or “expert” relating to contents of electronic messages 130 and 134 (or any other publicly accessible data source, such as X™ (formerly known as Twitter™). Orchestration engine 166 may be configured to implement analyzed data to form a “prompt” or any other data set to be applied to one or more data models (e.g., LLMs) to “enrich data” that may be implemented to provide a solution to improve or optimize generation of automated responses to agent user 121 or an electronically published article or information to enhance resolution of questions or issues regarding a product or a service.

In various examples, one or more inbound electronic messages may be disposed (e.g., as unmoderated electronic messages) in a queue so that electronic message platform 160 may facilitate moderation or filtering of the inbound electronic messages for posting into an online community, such as messages 130 and 134. In some examples, moderation of electronic messages may be based on a user input that may be configured to perform multiple actions regarding each electronic message in a queue. According to various examples, an electronic message may refer to an electronic post, content (e.g., or portion thereof, such as a unit of content), and the like, any of which may originate in various different formats and may be adapted for integration into an online community of, for example, categorized or classified content as presented in one or more webpages or any other electronic media. An electronic message or post may also refer to, for example, data representing an article (e.g., a knowledge article), a comment, a reply submitted to an online community, or the like.

Diagram 100 depicts an entity computing system 150 including a user interface 120 and a computing device 152 (e.g., one or more servers, including one or more processors and/or memory devices), both of which may be configured to moderate electronic messages and implement any number of actions to facilitate the moderation of such messages based on logic disposed in electronic message platform 160. As shown, computing device 152 may be configured, in at least one example, to provide one or more software functionalities and/or hardware structures to implement a community syndication controller 161, a message management controller 162, and a message moderation engine 164.

Community syndication controller 161 may be configured to host an online community to facilitate an electronic exchange of information and data among a group of users with related interests, goals, questions, problems, suggestions, experiences, etc., regarding one or more products, one or more services, or any other one or more topics or subject matter-related issues, or the like. Further, community syndication controller 161 may be configured to interact electronically with message moderation engine 164, which may be configured to moderate or filter (e.g., for approval) exchanges or postings of electronic messages in a moderated online community regardless of data formats (e.g., as a blog, a website, an email, a text message, or the like). Message management controller 162 may include logic configured to manage electronic interactions and messages among an online community as well as any other sources of data (e.g., online chat sessions, electronic messages directed to an entity rather than a community, or the like). In at least one example, community syndication controller 161 may be implemented with at least some functionality provided by an application configured to operate in accordance with Lithium Community technologies (formally of Lithium Technologies, LLC), Khoros® Communities of Khoros, LLC of Austin Texas, or other Communities of Khoros, LLC of Austin Texas, among other online community configurations. Further, message management controller 162 may be implemented using at least some functionality provided by an application configured to operate in accordance with “Modern Chat”-related technologies and “Khoros Care”-related technologies, both of Khoros, LLC of Austin Texas, among other technologies.

In some examples, a subset of an electronic community (e.g., online community) may include any number of electronic messages or posts that may relate to each other by subject matter or any other classification. As an example, an online community may be subdivided based on whether content relates to a “forum” (e.g., content directed to resolving a problem), an “idea” (e.g., content directed to proposed suggestions related to any item, such as a product), a “frequently-asked question” (e.g., content directed to searchable solutions that are determined to be effective), an “expert” classification (e.g., directed to users or electronic accounts associated with expert-based content), a “knowledge base” of searchable solutions to user inquiries, and any other classification or categorization.

Electronic messages may originate at any computing devices 109a to 109d, which are respectively associated with users 108a to 108d. In the example shown, user 108a may be associated with one or more computing devices, such as mobile computing device 105a or any type of computing device 109a, user 108b may be associated with one or more computing devices, such as mobile computing device 105b or any type of computing device 109b, user 108c may be associated with one or more computing devices, such as mobile computing device 105c or any type of computing device 109c, and user 108d may be associated with one or more computing devices, such as mobile computing device 105d or any type of computing device 109d. Note that any number of mobile and other types of computing devices may be configured to transmit and/or receive messages and are not limited to those shown. Any of mobile computing devices 105a to 105d and any of computing devices 109a to 109d may be configured to generate electronic messages to, for example, initiate moderation of those messages for inclusion in one or more data arrangements (e.g., in data storage) that constitute or implement an online community of messages.

Any one or more of message network computing systems 110a and 110b (including one or more applications) may be configured to receive and transmit electronic messages, regardless of a context, to convey an inquiry, experience, observation, request for assistance (e.g., in relation to a product or service), or any other information with or among any number of users for any reason. Such messages and content may be directed to resolving a problem via an inquiry, to providing experienced advice or suggestions (e.g., as an expert or an advocate), to provide observations as an idea to, for example, improve a product or a service, to request for assistance, or to exchange any information among users 108a to 108d, whereby electronic message platform 160 and/or community syndication controller 161 may be configured to host and moderate, for example, peer-to-peer exchanges of messages using message moderation engine 164. Similarly, or equivalently, one or more of message network computing systems 110a and 110b may be configured to communicate electronic message content in any form in any digital media or channel 107a. Also, one or more computing systems 113a and 113b may be configured to communicate electronic message content in any form in any digital media or channel 107a. Also, electronic message platform 160, community syndication controller 161, and/or message moderation engine 164 may be configured to moderate electronic message content originating at computing systems 113a and 113b as well as message network computing systems 110a and 110b.

Note that in some examples, channels 107a may be publicly-accessible channels, whereas channels 107b may constitute secure, private, and/or proprietary communication channels. As such, mobile computing devices 105a to 105d and computing devices 109a to 109d may be configured to submit electronic messages for posting in an online community via a secure data channel 107b.

In various examples, message network computing systems 110a and 110b may include any number of computing systems configured to propagate electronic messaging, including, but not limited to, computing systems including third party servers, such as third parties like Facebook™, X™ (e.g., Twitter™), LinkedIn™, Instagram™, Snapchat™, as well as other private or public social networks to provide social-media related informational data exchange services. Hence, message network computing systems 110a and 110b may include any social network computing system. Computing systems 113a and 113b (including one or more applications, such as text messaging applications) may be configured to provide any type of digital content, such as email, text messaging (e.g., via SMS messaging, Multimedia Messaging Service (“MMS”), WhatsApp™, WeChat™, Apple® Business Chat™, Instagram™ Direct Messenger, etc.), web pages (e.g., Facebook® websites and posts, Instagram® websites and posts, X™ or Twitter® websites and posts, etc.), audio (e.g., Spotify®-based content, etc.), video (e.g., YouTube™-based content, comments, etc.), and any other content.

According to some examples, message network computing systems 110a and 110b may include applications or executable instructions configured to facilitate interactions (e.g., social interactions) amongst one or more persons, one or more subpopulations (e.g., private groups or public groups), or the public at-large. Examples of message network computing systems 110a and 110b may include the above-mentioned electronic accounts for Facebook™, X™, LinkedIn™, Instagram™, and Snapchat™, as well as YouTube™, Pinterest™, Tumblr™, WhatsApp™ messaging, or any other platform, including Khoros® community, that may be configured to promote sharing of content, such as videos, audio, or images, as well as sharing ideas, thoughts, etc. in a socially-based environment, such as an online community moderated by implementing structures and functions of a message moderation engine 164 and/or any other component of electronic message platform 160 or entity computer system 150. According to some examples, content source computing systems 113a and 113b may include applications or executable instructions configured to promote an activity, such as a sports television network, a profession sports team, a news or media organization, a product producing or selling organization, and the like, or to promote sales or acquisition of goods or services. Content source computing systems 113a and 113b may be caused to implement websites, email, chat bots (e.g., “bots”), or any other digital communication channels, and may further implement electronic accounts to convey information via message network computing systems 110a and 110b.

In some examples, structures and/or functions of message network computing systems 110a and 110b and content source computing systems 113a and 113b may be implemented to operate similarly or equivalently as each other. Any electronic message may include a “tweet” (e.g., a message via a X™ or Twitter™ computing system), a “post” (e.g., a message via a Facebook™ computing system), or any other type of social network-based messages, along with any related functionalities, such as forwarding a message (e.g., “retweeting” via X™ or Twitter™), sharing a message, associating an endorsement of another message (e.g., “liking” a message, such as a Tweet™, or sharing a Facebook™ post, etc.), and any other interaction that may convey or otherwise may generate a “response” or electronic posts to an online community from one or more electronic accounts at relatively increased rates of transmissions or propagation to address concerns or statements that may otherwise affect a reputation of a brand. As such, message moderation engine 164 may be configured to moderate electronic posts to ensure compliance with policies, terms of use, legal regulations, and any other rule. According to various examples, an electronic message received via a network 111 can include any type of digital messaging that can be transmitted over any digital network (e.g., the Internet, etc.).

Entity computing system 150 is shown to include a computing device 120 and display configured to generate a user interface, such as a message moderation interface 122. Entity computing system 150 may also include a server computing device 152, which may include hardware and software, or a combination thereof, configured to implement an electronic message platform 160 configured to moderate a queue of electronic messages based on a user input that may be configured to perform multiple actions. In various examples, user 121 may be an agent user 121 acting in a role of a “moderator,” or as a user in any other function or role (e.g., a supervisory moderator, a quality control moderator, etc.).

Message moderation engine 164 may be configured to include logic to cause generation of a message moderation interface 122 at a computing device 120 to facilitate moderation or filtering of one or more electronic messages. Message moderation interface 122 may be configured to receive user input 124 to activate or enable automatic disposition (e.g., “auto disposition”) or automatic application of an action, such as automatically approving an unmoderated electronic message based on one or more portions of an electronic message based on functionality of orchestration engine 166 and/or data enhancement engine 168. For example, automatic approval of an unmoderated electronic message may be implemented based on derived data generated using model data generators 180. According to some examples, message moderation engine 164 may include logic that constitutes a computer program or set of executable instructions for a moderator application.

In some examples, agent user 121 may implement computing device 120 as a computerized tool (or a distributed portion thereof) to respond to a received message 130 or 134, as received into a moderator application (e.g., message moderation engine 164) to facilitate a moderated action. In some examples, a moderated action may be configured to cause assignment of an approved state automatically to an electronic message, thereby “automatically” approving the electronic message. For example, data enhancement engine 168 and automation engine 169 may be configured to generate a proposed response to agent user 121 based on data received from model data generators 18 (i.e., responsive to prompt applied thereto).

In view of the foregoing, structures and/or functionalities depicted in FIG. 1 as well as other figures herein, illustrate one or more applications, algorithms, systems and platforms to leverage or otherwise analyze content of electronic messages to cause one or more actions automatically to be applied to an electronic message or post under moderation and review, according to some embodiments.

Implementation of orchestration engine 166, as described herein, may automatically implement one or more data models (or a combination of data models), such as large language models (“LLMs”) or machine-learning algorithms to, for example, provide automated moderation and resolution based on any contents of any electronic message (e.g., messages 130 and 134) regardless of communication channels 107b, 107a, or the like. For example, data enhancement engine 168 may include logic to create information (e.g., as a knowledge article) that may be presented automatically to users 108a, 108b, 108c, and 108d as a response to applying prompt data to one or more model data generators 180.

Note that the above-described may implement, for example, functionalities provided by Khoros® Manage View user interface and a Khoros® Community software platform, or any Khoros product or service. Any of described elements or components set forth in FIG. 1, and any other figure herein, may be implemented as software, applications, executable code, application programming interfaces (“APIs”), processors, hardware, firmware, circuitry, or any combination thereof.

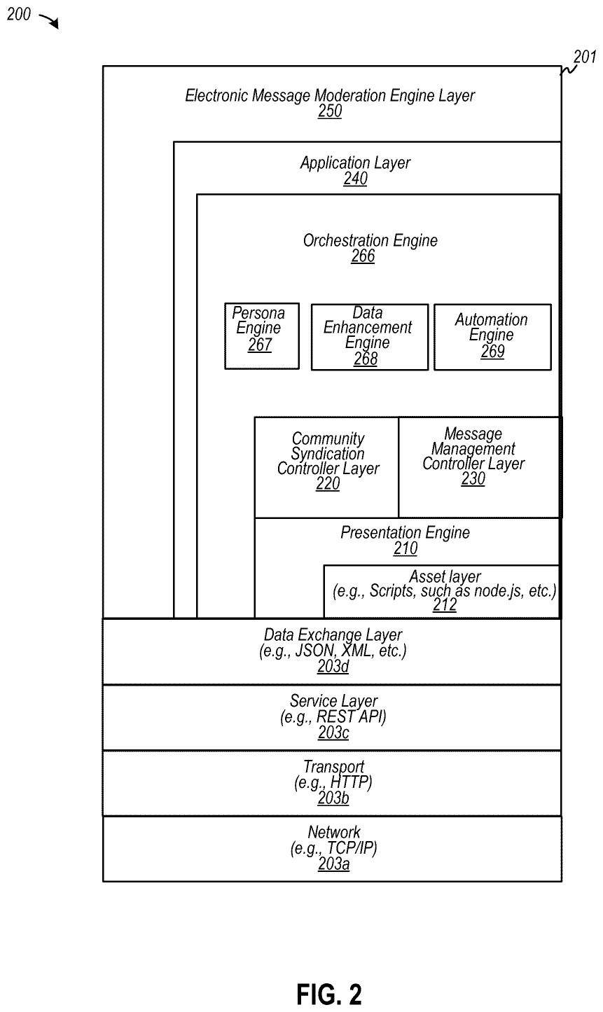

FIG. 2 illustrates an exemplary layered architecture for implementing a moderator application, according to some examples. Diagram 200 depicts application stack (“stack”) 201, which is neither a comprehensive nor a fully inclusive layered architecture for moderating electronic posts and messages of an online community or social media network, including performing automatic actions using, for example, data and responses derived from one or more model data generators, such as LLMs or other natural language processing (“NLP”) or machine-learning algorithms. One or more elements depicted in diagram 200 of FIG. 2 may include structures and/or functions as similarly-named or similarly-numbered elements depicted in other drawings, or as otherwise described herein, in accordance with one or more examples, such as described relative to FIG. 1 or any other figure or description herein.

Application stack 201 may include an electronic message moderation engine layer 250 upon application layer 240, which, in turn, may be disposed upon any number of lower layers (e.g., layers 203a to 203d). Electronic message moderation engine layer 250 may be configured to provide functionality and/or structure to implement a moderator application, as described herein. Electronic message moderation engine layer 250 and application layer 240 may be disposed on data exchange layer 203d, which may be implemented using any programming language, such as HTML, JSON, XML, etc., or any other format to effect generation and communication of requests and responses among computing devices and computational resources constituting an enterprise and an enterprise resource planning application and/or platform. Data exchange layer 203d may be disposed on a service layer 203c, which may provide a transfer protocol or architecture for exchanging data among networked applications. For example, service layer 203c may provide for a RESTful-compliant architecture and attendant web services to facilitate GET, PUT, POST, DELETE, and other methods or operations. In other examples, service layer 203c may provide, as an example, SOAP web services based on remote procedure calls (“RPCs”), or any other like services or protocols (e.g., APIs). Service layer 203c may be disposed on a transport layer 203b, which may include protocols to provide host-to-host communications for applications via an HTTP or HTTPS protocol, in at least this example. Transport layer 203b may be disposed on a network layer 203a, which, in at least this example, may include TCP/IP protocols and the like. Note that in accordance with some examples, layers 203a to 203d facilitate implementation of a risk management data channel as set forth herein.

As shown, electronic message moderation engine layer 250 may include (or may be layered upon) an application layer 240 that includes logic constituting an orchestration engine 266 as well as a persona engine 267, a data enhancement engine 268, and an automation engine 269, any of which has functionalities described in FIG. 1 and elsewhere herein. Also shown, application layer 240 includes logic constituting a community syndication controller layer 220, a message management controller layer 230, a presentation engine 210, and an asset layer 212. According to some examples, community syndication controller 220 may include logic to implement an online community, such as the Lithium Community (formally of Lithium Technologies, LLC), Khoros Communities of Khoros, LLC of Austin Texas, or any Communities of Khoros, LLC of Austin Texas, among other online community configurations. Further, message management controller layer 230 may include logic to implement at least some functionality provided by an application configured to operate in accordance with “Modern Chat”-related technologies and “Khoros Care”-related technologies, both of Khoros, LLC of Austin Texas, among other technologies. Presentation engine layer 242 may include logic configured to facilitate presentation of electronic messages, as well as associated functionalities. In some examples, an asset layer 212 may be configured to implement node.js, which may be a cross-platform, JavaScript runtime environment. In some cases, node.js may execute JavaScript code independent of a browser, or any other protocol, any other programming language, or any other set of executable instructions. Node.js is maintained by the Linux Foundation of San Francisco, CA, USA.

Any of the described layers of FIG. 2 or any other processes described herein in relation to other figures may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including, but not limited to, Python™, ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by Khoros, LLC, or the like. The above-described techniques may be varied and are not limited to the embodiments, examples or descriptions provided.

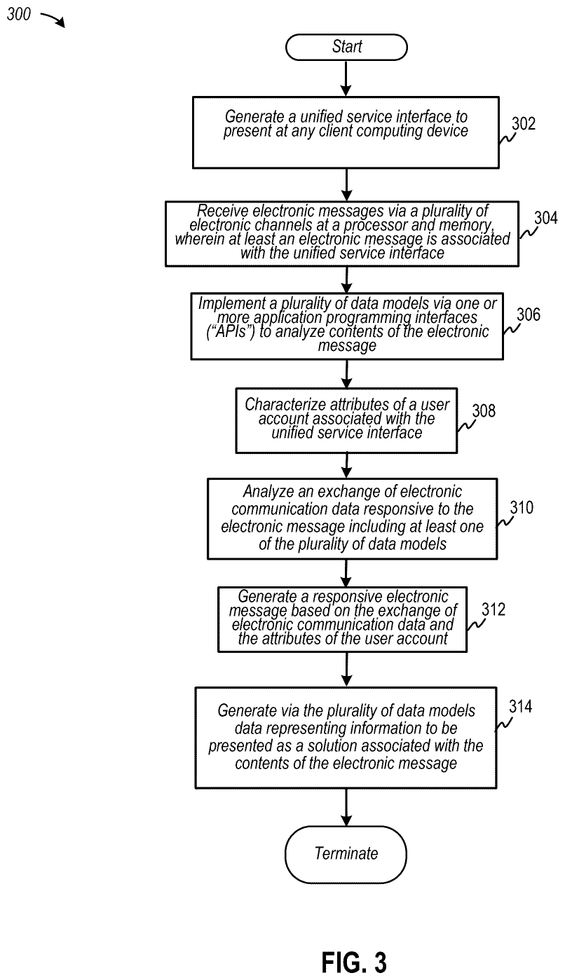

FIG. 3 is a flow diagram as an example of moderating an electronic message, according to some embodiments. Flow 300 may be an example of facilitating moderation of electronic messages, postings, content, etc., to determine whether to include electronic messages in an electronic community (or any subset thereof). In some examples, a subset of an electronic community (e.g., online community) may include any number of electronic messages or posts that may relate to each other by subject matter or any other classification. As an example, an online community may be subdivided based on whether content relates to a “forum” (e.g., content directed to resolving a problem), an “idea” (e.g., content directed to proposed suggestions related to any item, such as a product), a “frequently-asked question” (e.g., content directed to searchable solutions that are determined to be effective), an “expert” classification (e.g., directed to users or electronic accounts associated with expert-based content), and any other classification or categorization, at least based on data derived from one or more data models (or a combination of data models), such as large language models (“LLMs”) or machine-learning algorithms.

At 302, an orchestration engine application, an electronic message platform application, or an entity computing system may be configured to cause generation of a unified service interface with which a user (e.g., an online customer) may engage to resolve any issues via any number of electronic channels as an omnichannel request (e.g., requests via electronic messaging agnostic to electronic medium). Further, an orchestration engine application, an electronic message platform application, or an entity computing system may be configured to perform one or more actions automatically, such as approving or generating an electronic message as a post in the electronic community, according to some examples. In some implementations, an application may be implemented in association with a computing platform configured to host a syndication of subsets of electronic messages (e.g., an electronic community). An application may be configured to analyze one or more electronic messages to, for example, identify whether to apply a one or more actions (e.g., at least one of which may be performed automatically) in association electronic message.

At 304, electronic messages via a plurality of electronic channels at a processor and memory may be received. At least an electronic message is associated with the unified service interface, in accordance with some examples.

At 306, a plurality of data models may be implemented via one or more application programming interfaces (“APIs”) to analyze contents of the electronic message and to generate proposed responses in real-time (or near real-time) or as an electronic post as a “knowledge article” describing information associated with a subset of incoming electronic messages. APIs may be configured to access multiple model data generators, such as LLMs, or equivalents thereof.

At 308, attributes of a user account associated with the unified service interface may be characterized. For example, attributes of a user account (and associated user) may be classified or characterized as an advocate or expert that may provide self-service information and solutions relating to content associated with received electronic messages. A persona engine can generate persona data of users by evaluating needs within a customer life cycle and analyzing customer details like demographics of a user, transaction history of a user, and net promoter scores (“NPS”) as well as customer satisfaction scores (“CSAT”) of a user. Persona data thus may be used to prioritize or influence generation of data for presentation to a community at-large.

At 310, flow 300 may provide for analyzation of an exchange of electronic communication data responsive to an electronic message. In at least one example, analyzation of an electronic message may include implementing at least one of a plurality of data models to perform analysis.

At 312, a responsive electronic message may be generated based on an exchange of electronic communication data and attributes of a user account and associated user (e.g., persona data).

At 314, data representing information may be generated to be presented as a solution associated with the contents of the electronic message, whereby the data generated may be a result of implementing one or more data models (“LLMs”), machine-learning algorithms, or the like.

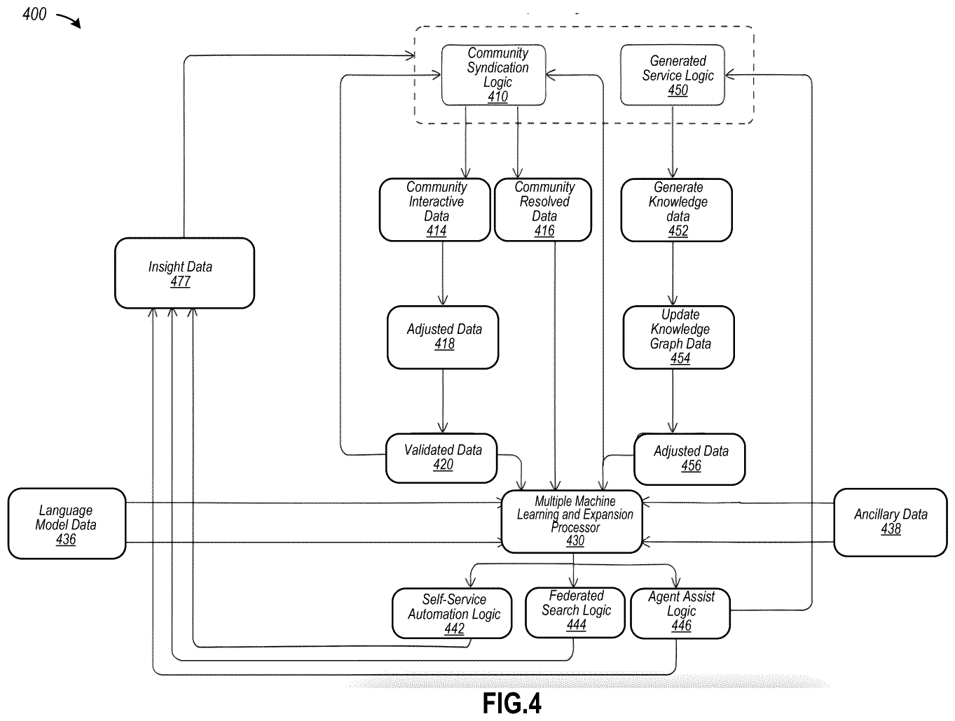

FIG. 4 is an example of an architecture to implement an orchestration engine, according to some examples. Diagram 400 includes a multiple machine learning and knowledge expansion processor 430, which may be implemented as logic configured to access multiple data models (e.g., multiple LLMs, machine-learning algorithms-including neural networks, etc.) as one or more retrieval-augmented generation (“RAG”) algorithms. For example, a RAG algorithm may be configured to enhance data accuracy (e.g., avoiding “hallucinations”) of generative data models (e.g., AI-based data models) with facts from external sources in the form, for example, of a prompt or prompt data. In various examples, one or more portions and elements of FIG. 4 may be implemented to constitute a data enrichment engine of FIG. 1 and otherwise described herein. Any component of FIG. 4 may be implemented in hardware, software, or any combination thereof.

As shown, multiple machine learning and knowledge expansion processor 430 may access language model data 436 and ancillary data 438. Language model data 436 may include data from a data source representing “frequently asked questions” (“FAQs”) and data sources representing a learning management system (“LMS”) configured to manage online training content derive from exchanges of electronic messages, generate proposed automated responses that may or may not include agent user assistance, and monitoring of data generation, usage, and communication within an entity's computing platform (e.g., a computing platform hosting an online community or other CRM functionalities). Ancillary data 438 may include data from data sources including any publicly-available data (e.g., data scraped from a variety of web sites) and data originating through a “help” portal through which electronic message may be exchanged.

Multiple machine learning and knowledge expansion processor 430 is configured to generate data to apply to self-service automation logic 442, federation search logic 444, and agent assist logic 446. Self-service automation logic 442 may be configured to provide a unified service interface (i.e., a “conversational interface”) through which any number of applications and algorithms may be implemented to access multiple knowledge data sources, community solutions of an online community, and any number of agent-assisted responses. Federation search logic 444 may be configured to perform any variety of searches of data sources accessible over any number of electronic communication channels, thereby providing an omnichannel search over internal and external data sources (e.g., any social data network) and data bases, including knowledge graph data bases (e.g., RDF-based data bases). Agent assist logic 446 may be configured to provide functionality of moderating content of an online community as well as providing responses to electronic messages.

Self-service automation logic 442, federation search logic 444, and agent assist logic 446 may be configured to generate data, such as insight data 477. Insight data 477 may be used to provide analytically-derived information to an agent user or any other user that may wish to modify an application that directs a workflow describing the processes of moderating responses to electronic message content. Insight data 477 is shown to be applied to community syndication logic 410 and generated service logic 450.

Community syndication logic 410 may be configured to manage or assist in managing one or more online communities to provide responses, knowledge articles, and the like. Community syndication logic 410 may consume insight data 477 to identify community interactive data 414, which may include “topics” with exchanges of electronic messages as replies. A topic may be one or more words or concepts derived, for example, using natural language processing (“NPL”) that may summarize content of one or more electronic messages. Such content or topic data may be automatically classified and tagged with a label representing one or more portions of content. In some cases, community interactive data 414 may be flagged by an AI-based algorithm and classified accordingly. Community interactive data 414 may be adjusted to form adjusted data 418, for example, under moderator review, and may be therefore validated as validated data 420. Validated data 420 may be provided to multiple machine learning and knowledge expansion processor 430 to modify its functionality. Community syndication logic 410 may be configured to generate community resolved data 416, which may include content or tagged topical data representing associated with responses that may indicate resolutions for subsequent interaction with electronic messages. As shown, community resolved data 416 may be applied to multiple machine learning and knowledge expansion processor 430 to modify its functionality.

Generated service logic 450 may be configured to generate data to modify one or more knowledge data sources, including one or more knowledge graphs, to form or generate knowledge data 452. Hence, generated knowledge data 452 may be used to update or modify knowledge graph data 454. In some cases, knowledge graph data 454 may be adjusted, for example, under moderator review to form adjusted data 456, which, in turn, may be applied to multiple machine learning and knowledge expansion processor 430 to modify its functionality.

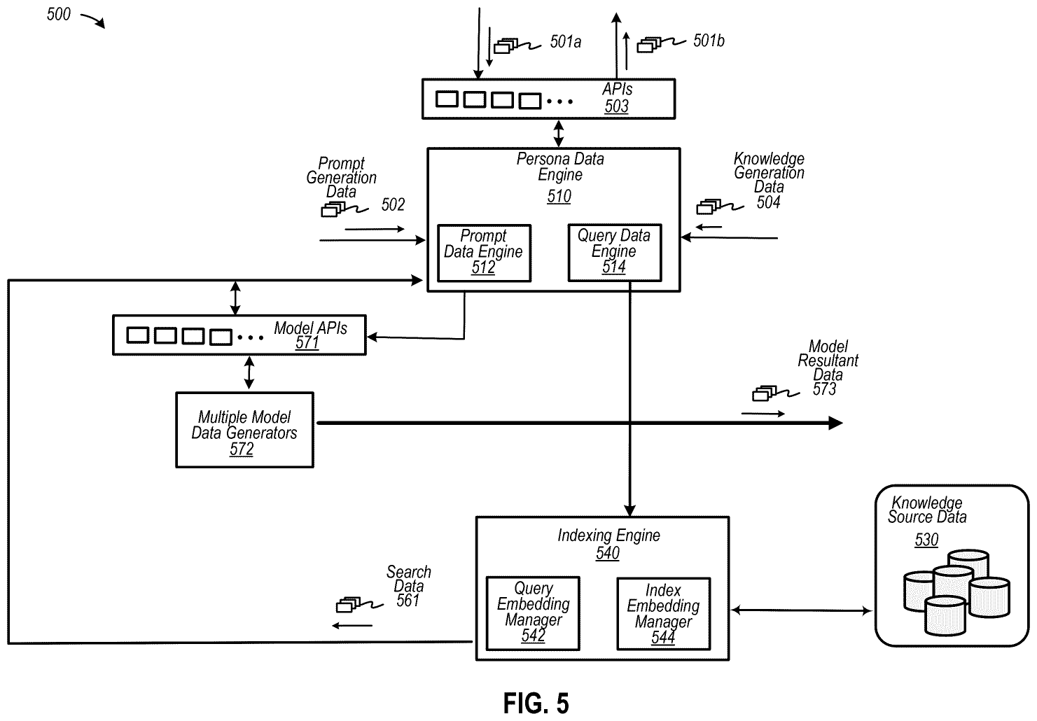

FIG. 5 is an example of an architecture that may implement or interface with any number of model data generators in an agnostic manner, at least in some examples. Diagram 500 depicts an architecture to support, for example, one or more retrieval-augmented generation (“RAG”) algorithms. As shown, a persona data engine 510 may receive electronic messages 501a and may transmit electronic messages 501b via any number of APIs 503 (or endpoints). Electronic messages 501a may include content originating via any text-based electronic communication, as well chat-based communication (e.g., automated data exchanges using, for example, chat bots). Electronic messages 501b may include automated responses as well as any agent-assisted responses. In some examples, diagram 500 may be configured to implement “Helix,” which is provided by Khoros®.

Persona data engine 510 may include a prompt data engine 512 and a query data engine 514. Prompt data engine 512 may be configured to receive prompt generation data 502, which may include data representing one or more prompt templates with which to form a prompt. Prompt data engine 512 may transmit a prompt via any model APIs 571 configured to apply the prompt to multiple model data generators 572, which may include one or more data models (or a combination of data models), such as large language models (“LLMs”), machine-learning algorithms, deep-learning algorithms and any neural network-based algorithm (e.g., convolutional neural network (“CNN”) algorithms, recurrent neural network (“RNN”) algorithms, or any artificial neural network (“ANN”) algorithm, etc.). As shown, multiple model data generators 572 may generate model resultant data 573 as an automated response, a modification to a knowledge graph, a self-generated knowledge article, a proposed response for moderator review, and the like.

Query data engine 514 may be configured to receive knowledge generation data 504 configured to generate one or more queries of one or more data sources (including one or more knowledge graphs and/or data bases). Query data engine 514 may be configured to generate data to apply to an indexing engine 540. As shown, indexing engine 540 may include a query embedding manager 542 and an index embedding manager 544.

Indexing engine 540 may be configured to provide a data schema or data structure as search data 561 including data objects configured to query one or more multiple model data generators 572 including one or more LLMs or the like. Index embedding manager 544 may be configured to receive data from multiple sources of knowledge source data 530 and may be further configured to index data from knowledge source data 530 (e.g., structured data and unstructured data, as well as text-based documents, HTML-based documents, PDFs, NoSQL, relational databases, SQL, and other data formats). Query embedding manager 542 may include logic configured to embed, for example, an alpha-numeric representation of data to provide for providing identification of semantics or other attributes of text or any other data format (e.g., audio data, video data, image data, etc.) In some examples, indexing engine 540 may include or implement services or software similar or equivalent to that provided by Llamaindex, Inc., of San Francisco, CA. Search data 561 may include data configured to modify functionalities of prompt data engine 572 to optimize formation of prompts submitted via model APIs 571 to multiple model data generators 572 (e.g., LLMs).

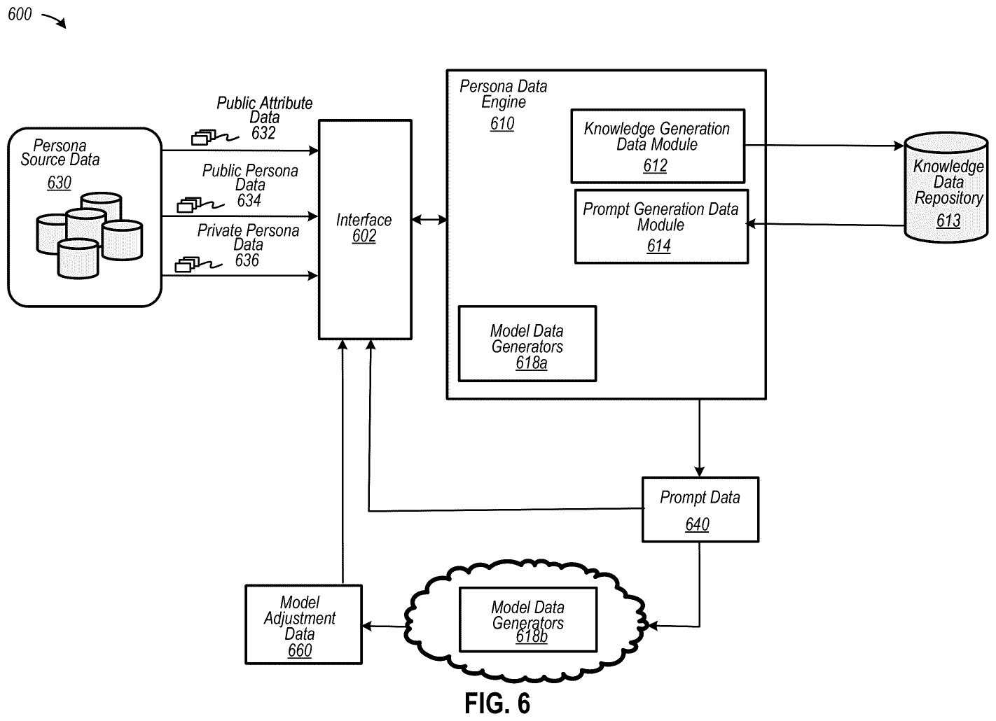

FIG. 6 is a diagram depicting an implementation of an exemplary persona data engine, according to some examples. Diagram 600 depicts a persona data engine 610 configured to leverage attributes of users (as a persona data source) to optimize self-service responses to electronic messages including content relating to questions, issues, and other requests regarding an entity's product or service. Persona data engine 610 may include logic configured to provide a way to configure, for example, a LLM (or any model generator 618a or 618b) with a prompt to access any different knowledge source agnostically (e.g., regardless of electronic channel protocols, data base protocols and structures, publicly or private data sources, etc.).

As shown, persona data engine 610 may be configured to access persona source data 630 that may include public attribute data 632 (e.g., public trait data), public persona data 634 (e.g., data available publicly), and private persona data 636 (e.g., generally known to an entity and publicly inaccessible). Persona source data 630 may be accessed via interface 602 (e.g., one or more APIs).

Persona data engine 610 may include a knowledge generation data module 612, a prompt generation data module 614, and optional model data generators 618a. Knowledge generation data module 612 may be configured to access a knowledge data repository 613 to, for example, retrieve data representing associated knowledge (or any data) relating to a persona linked to a user. Data from knowledge data repository 613 may be consumed by prompt generation data module 614 to generate prompt data 640. Prompt data 640 may be applied via APIs (not shown) to any number of model data generators 618b, which may include LLMs. Model data generators 618b may generate model adjustment data 660 to adjust subsequent generation of prompts based on persona attributes, including traits or other attributes associated with a user or a user account. As shown, prompt data 640 may be transmitted back via interface 602 to calibrate functionality of persona data engine 610.

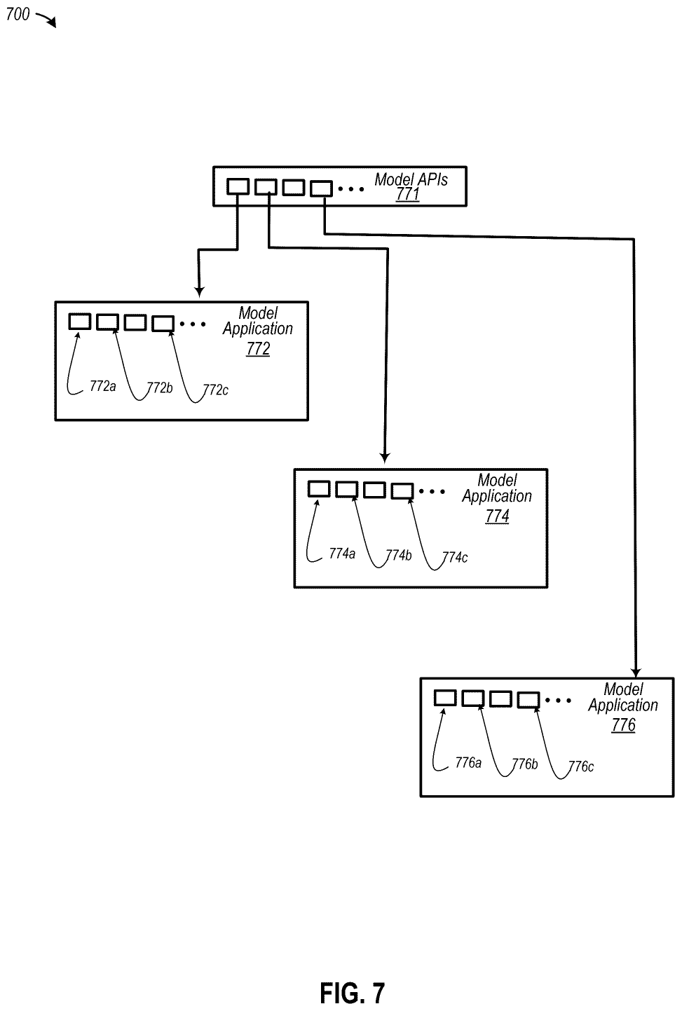

FIG. 7 depicts examples of model APIs to access any number of model data applications and generators in accordance to some examples. Diagram 700 depicts a number of model APIs 771, each of which is configured to access a particular model data generator (e.g., a particular LLM) agnostically. For example, an API may access model application 772 to access data including text data 772a, chat data 772b, and model parameters 772c, such as “temperature” and other LLM parameters. In one instance, model application 772 may be implemented using OpenAI™ and variants thereof (e.g., ChatGPT). As another example, an API may access model application 774 to access data including text data 774a, chat data 774b, and model parameters 774c as LLM parameters. In one instance, model application 772 may be implemented using VertexAI™ and variants thereof. Model APIs 771 may access any product or service providing any LLM or machine-learning model, such as model application 776. As such, model APIs 771 may access information and data representing text data 776a, chat data 776b, and model parameter data 776c.

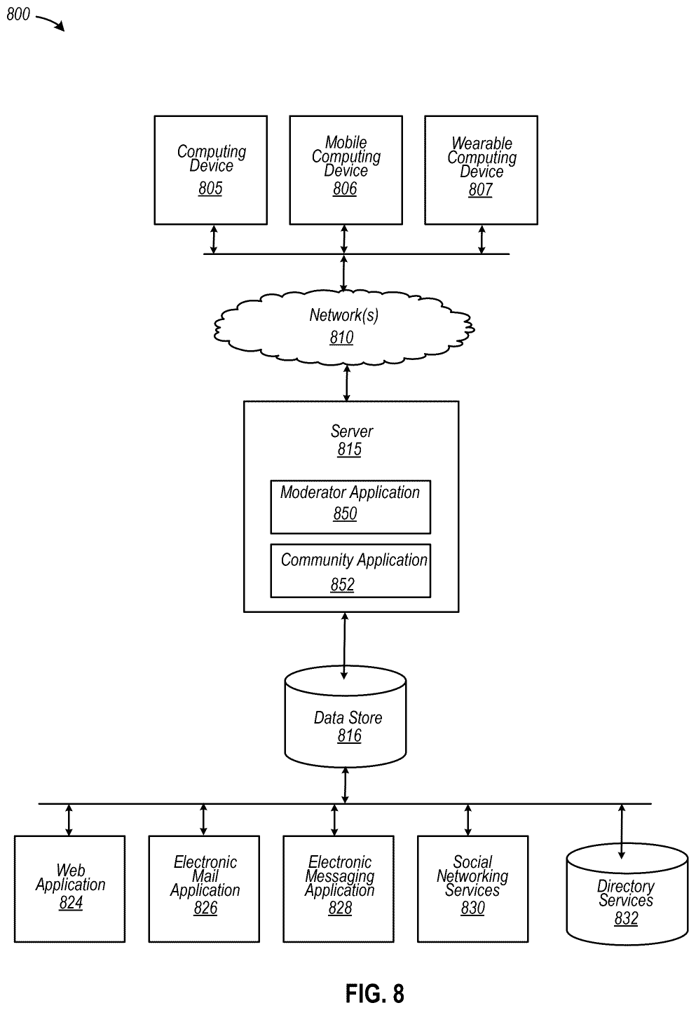

FIG. 8 depicts an example of a system architecture to provide a computing platform to host a syndication of electronic messages and posts for moderation, according to an example. Content, messages, and/or posts may be stored in (or exchanged with) various communication channels or storage devices as unmoderated or moderated content. For example, various units of content may be stored using one or more of a web application 824, an email application service 826, an electronic messaging application 828 (e.g., a texting or messenger application), social networking services 830 and a directory services repository 832 (e.g., an AWS® directory service provided by Amazon Web Services, Inc., or any other directory service). A server 815 may implement a moderator application 850 implementing an orchestration engine for use by moderator-users and a community application 852 for use by client applications and devices to support or provide an online community (e.g., including any social network). As an example, server 815 may be a web server providing the applications 850 and 852 via networks 810. As an example, a client computing device may be implemented and/or embodied in a computer device 805, a mobile computing device 806 (e.g., a smart phone), a wearable computing device 807, or other computing device. Any of these client computing devices 805 to 807 may be configured to transmit content (e.g., as electronic posts) from the store 816, and may be configured to receive content (e.g., other electronic posts constituting an online community).

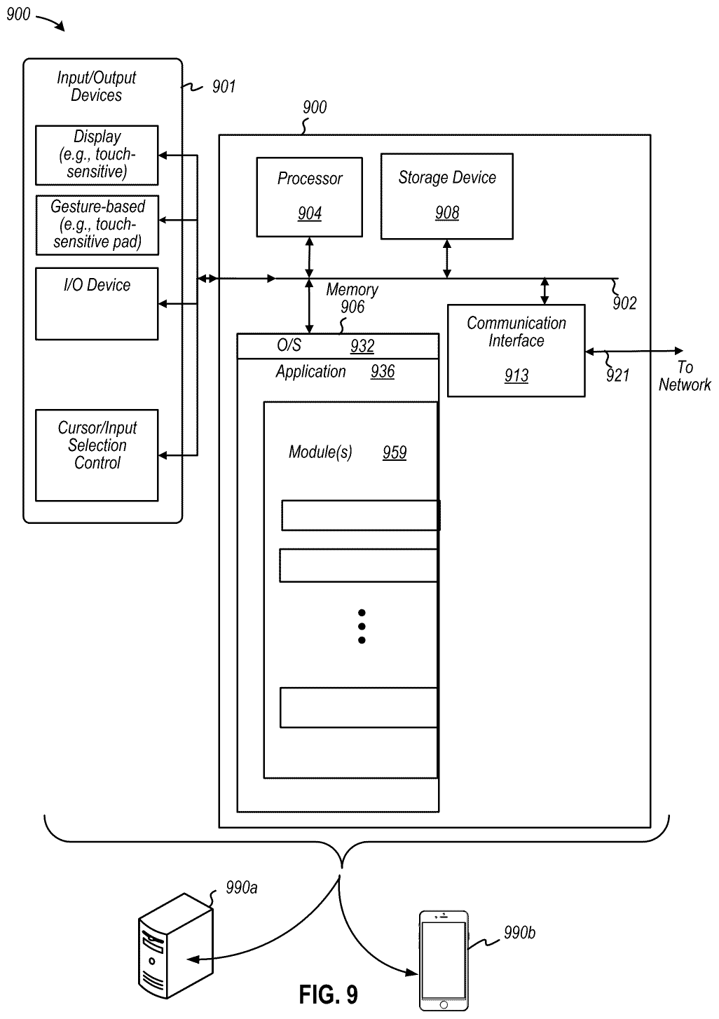

FIG. 9 illustrates examples of various computing platforms configured to provide various functionalities to components of an electronic message platform 900 to moderate electronic messages. Computing platform 900 may be used to implement computer programs, applications, methods, processes, algorithms, or other software, as well as any hardware implementation thereof, to perform the above-described techniques.

In some cases, computing platform 900 or any portion (e.g., any structural or functional portion) can be disposed in any device, such as a computing device 990a, mobile computing device 990b, and/or a processing circuit in association with initiating any of the functionalities described herein, via user interfaces and user interface elements, according to various examples.

Computing platform 900 includes a bus 902 or other communication mechanism for communicating information, which interconnects subsystems and devices, such as processor 904, system memory 906 (e.g., RAM, etc.), storage device 908 (e.g., ROM, etc.), an in-memory cache (which may be implemented in RAM 906 or other portions of computing platform 900), a communication interface 913 (e.g., an Ethernet or wireless controller, a Bluetooth controller, NFC logic, etc.) to facilitate communications via a port on communication link 921 to communicate, for example, with a computing device, including mobile computing and/or communication devices with processors, including database devices (e.g., storage devices configured to store atomized datasets, including, but not limited to triplestores, etc.). Processor 904 can be implemented as one or more graphics processing units (“GPUs”), as one or more central processing units (“CPUs”), such as those manufactured by Intel® Corporation, or as one or more virtual processors, as well as any combination of CPUs and virtual processors. Computing platform 900 exchanges data representing inputs and outputs via input-and-output devices 901, including, but not limited to, keyboards, mice, audio inputs (e.g., speech-to-text driven devices), user interfaces, displays, monitors, cursors, touch-sensitive displays, touch-sensitive input and outputs (e.g., touch pads), LCD or LED displays, and other I/O-related devices.

Note that in some examples, input-and-output devices 901 may be implemented as, or otherwise substituted with, a user interface in a computing device associated with, for example, a user account identifier in accordance with the various examples described herein.

According to some examples, computing platform 900 performs specific operations by processor 904 executing one or more sequences of one or more instructions stored in system memory 906, and computing platform 900 can be implemented in a client-server arrangement, peer-to-peer arrangement, or as any mobile computing device, including smart phones and the like. Such instructions or data may be read into system memory 906 from another computer readable medium, such as storage device 908. In some examples, hard-wired circuitry may be used in place of or in combination with software instructions for implementation. Instructions may be embedded in software or firmware. The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks and the like. Volatile media includes dynamic memory, such as system memory 906.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding, or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by computing platform 900. According to some examples, computing platform 900 can be coupled by communication link 921 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 900 may transmit and receive messages, data, and instructions, including program code (e.g., application code) through communication link 921 and communication interface 913. Received program code may be executed by processor 904 as it is received, and/or stored in memory 906 or other non-volatile storage for later execution.

In the example shown, system memory 906 can include various modules that include executable instructions to implement functionalities described herein. System memory 906 may include an operating system (“O/S”) 932, as well as an application 936 and/or logic module(s) 959. In the example shown in FIG. 9, system memory 906 may include any number of modules 959, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. These can be varied and are not limited to the examples or descriptions provided.

In some embodiments, modules 959 of FIG. 9, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 959 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 959 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, modules 959 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
causing generation of a unified service interface to present at any client computing device;
receiving electronic messages via a plurality of electronic channels at a processor and memory, wherein at least an electronic message is associated with the unified service interface;
implementing a plurality of data models via one or more application programming interfaces (“APIs”) to analyze contents of the electronic message;
characterizing attributes of a user account associated with the unified service interface;
analyzing an exchange of electronic communication data responsive to the electronic message including at least one of the plurality of data models;
generating a responsive electronic message based on the exchange of electronic communication data and the attributes of the user account; and
generating via the plurality of data models data representing information to be presented as a solution associated with the contents of the electronic message.

2. The method of claim 1 wherein implementing the plurality of data models comprises:
implementing a plurality of machine learning algorithms.

3. The method of claim 1 wherein implementing the plurality of data models comprises:
implementing a plurality of large language modeling (“LLM”) algorithms.

4. The method of claim 1 wherein characterizing attributes of the user account associated with the unified service interface comprises:
generating data representing a persona associated with the user account.

5. The method of claim 1 wherein receiving the electronic messages comprises:
receiving the electronic message into an automation algorithm or at a moderator computing device.

6. The method of claim 1 wherein generating the data representing information to be presented as the solution comprises:
implementing the plurality of data models to form data representing an article to be distributed publicly to resolve issues associated with the content of the electronic message.

7. The method of claim 1 further comprising:
generating data representing a prompt to apply to the plurality of data models as a function of the attributes of the user account or the contents of the electronic message, or both.

8. A system comprising:
a data store configured to store an application in association with a computing platform configured to host subsets of electronic messages; and
a processor configured to execute instructions to implement at least a portion of the application configured to:
cause generation of a unified service interface to present at any client computing device;
receive electronic messages via a plurality of electronic channels at a processor and memory, wherein at least an electronic message is associated with the unified service interface;
implement a plurality of data models via one or more application programming interfaces (“APIs”) to analyze contents of the electronic message;
characterize attributes of a user account associated with the unified service interface;
analyze an exchange of electronic communication data responsive to the electronic message including at least one of the plurality of data models;
generate a responsive electronic message based on the exchange of electronic communication data and the attributes of the user account; and
generate via the plurality of data models data representing information to be presented as a solution associated with the contents of the electronic message.

9. The system of claim 8, wherein the processor is further configured to:
implement a plurality of machine learning algorithms.

10. The system of claim 8, wherein the processor is further configured to:
implement a plurality of large language modeling (“LLM”) algorithms.

11. The system of claim 8, wherein the processor configured to characterize attributes of the user account associated with the unified service interface is further configured to:
generate data representing a persona associated with the user account.

12. The system of claim 8, wherein the processor configured to receive the electronic messages is further configured to:
receive the electronic message into an automation algorithm or at a moderator computing device.

13. The system of claim 8, wherein the processor configured to generate the data representing information to be presented as the solutions is further configured to:
implement the plurality of data models to form data representing an article to be distributed publicly to resolve issues associated with the content of the electronic message.

14. The system of claim 8, wherein the processor is further configured to:
generate data representing a prompt to apply to the plurality of data models as a function of the attributes of the user account or the contents of the electronic message, or both.

15. A non-transitory computer readable medium having one or more computer program instructions configured to perform a method, the method comprising:
causing generation of a unified service interface to present at any client computing device;
receiving electronic messages via a plurality of electronic channels at a processor and memory, wherein at least an electronic message is associated with the unified service interface;
implementing a plurality of data models via one or more application programming interfaces (“APIs”) to analyze contents of the electronic message;
characterizing attributes of a user account associated with the unified service interface;
analyzing an exchange of electronic communication data responsive to the electronic message including at least one of the plurality of data models;
generating a responsive electronic message based on the exchange of electronic communication data and the attributes of the user account; and
generating via the plurality of data models data representing information to be presented as a solution associated with the contents of the electronic message.

16. The method of claim 15 wherein implementing the plurality of data models comprises:
implementing a plurality of machine learning algorithms.

17. The method of claim 15 wherein implementing the plurality of data models comprises:
implementing a plurality of large language modeling (“LLM”) algorithms.

18. The method of claim 15 wherein characterizing attributes of the user account associated with the unified service interface comprises:
generating data representing a persona associated with the user account.

19. The method of claim 15 wherein receiving the electronic messages comprises:
receiving the electronic message into an automation algorithm or at a moderator computing device.

20. The method of claim 15 wherein generating the data representing information to be presented as the solution comprises:
implementing the plurality of data models to form data representing an article to be distributed publicly to resolve issues associated with the content of the electronic message.
